(19) United States
(12) Patent Application Publication
(10) Pub. No.: US 2002/0196296 A1
(43) Pub. Date: Dec. 26, 2002

(54) One pass filmless 3D motion on printable material

(76) Inventor: Jing Lu Gu, Fremont, CA (US)

Correspondence Address: ROGER PITKIN, 45275 NORTHPORT CT, FREMONT, CA, 94538, US

(21) Appl. No.: 09/885,418

(22) Filed: Jun. 21, 2001

(51) Int. Cl. B41J 2/01

(52) U.S. Cl. 347/1

(57) ABSTRACT

The application of inkjet printing directly on lenticular lenses to create three-dimensional animated images that do not require film or complex interlacing techniques.

### BACKGROUND OF THE INVENTION

Lenticular printing has been a developed technology for many years. It requires sophisticated interlacing techniques to provide film that is printed in close tolerance by large offset printers on lenticular lenses. The printed images are matched to lens sheets that have been manufactured to a set LPI (lines per inch) and thickness of the material. The relationship between the LPI and thickness of the lenses determines the type of 3D and animation that can be seen by the human eye from various distances and positions.

Because of the interlacing and large press requirements lenticular printing has been feasible only with very high volume to amortize the film and setup costs and the lead times are long.

Because of the exact registration requirements (up to 5 thousandths of an inch) only licensed trained professional printers have been able to produce quality images. Because of these requirements the process has seen relatively little use and then only in high volume for promotional purposes. Individuals and businesses have not been able to take advantage of the remarkable effects of 3D animated images. Lenticular technology has never been able to be used with lower cost inkjet printers or wide format inkjet printers.

In the current process film is required as in all offset printing. When it is used to produce lenticular images digital output images are interlaced together so that objects appear to move, change size and direction etc. when these printed images are interfaced with lenticular lens sheets. The interlacing as seen through the lens creates the 3D and animated effects. This film and printing process is expensive and must occur whether only one or one hundred prints are produced.

In this interlacing process each image is divided into parallel strips and distorted so that each strip appears thinner. The images are interleaved so that one very thin strip of each image is printed next to a strip from the next. Precise positioning is required since most motion image prints are color photographs that need to be printed in four separate passes. More sophisticated lenticular images can have dozens of images aligned beneath each lens making it even more difficult. 3D images are created by blending images of two slightly different perspective points into a single image giving the impression of depth.

The lenses are optical grade and half cylindrical sitting in parallel lines on top of several specially prepared images. The lenses refract the images beneath them so that as the viewer position changes the image creates the illusion of motion.

These clear lens sheets also require a white adhesive material to be attached to the back of the lens to provide a contrast for the images to be seen properly unless the images are backlit as in a light box.

There are several problems with this process when applied to the printed lens. The white material is applied typically by a cold or hot laminate process and is very difficult to create an even alignment. Cold laminate is not always secure and results in removing the printed image. Hot laminating process will tend to decrease the resolution of the image as it tends to melt from the heat application.

There are two additional printing processes that can print lenticular images, silkscreen and photo processing. Silkscreen does not use film and it prints on the lens but the resolution is poor (only 20 to 40 lines per inch) and the material is thick ⅛^{th} of an inch and heavy. Photo processing requires film and a separate step for each image incorporated making it very high cost and limiting it to small size lenticular images.

### SUMMARY OF THE INVENTION

It is the object of this invention to overcome the limitations of current lenticular printing technology as described in the background and prior art of the invention.

It is also the object to print lenticular images directly on a lenticular lens with an inkjet printer to lower costs and make the process more acceptable for mass production.

It is yet a further object to perform said printing without the normal film and interlacing process required by offset press lenticular printing reducing the requirement for exact registration.

It is another object to prepare the lens with high lines per inch and minimal thickness to achieve maximum results in the majority of low cost inkjet printers as well as large format inkjet printers.

It is yet a further object to develop an inkjet clear coating to apply to the back of the lens that will achieve the result of quality printing on the lens as well as proper adhesion and drying capability.

It is yet another object to develop the proper white, semi opaque, thin coating to apply over the inkjet coating to provide a solid background for the lens images without having to add a separate white adhesive material to the back. This coating is microporous and is such that it can also be used with backlit images as the printed image inks penetrate the white coating and light passes through it. The result is lower manufacturing cost. The coating provides UV protection for longer ink life and the printable surface has less tendency to scratch or show fingerprints or damage with the white coating. When this white coating is applied over the clear coating and is printed the inkdrop passing through the coating is reduced in size causing a higher resolution image when viewed through the lens from the other side. In addition, the white coating allows most wide format printers to recognize that there is media to print. If the lens material and coating are clear the printer cannot set the parameters required to begin printing.

It is yet a further object to prevent the need for a separate white adhesive laminated backing because when the backing is applied it causes problems with the images. If it is a hot laminate the heat can cause the image to blur. If it is a cold pressure laminate the pressure can cause resolution changes in the image. Since the lamination can only be applied to the printed side and not the lens side the printed media will tend to curl.

### BRIEF DESCRIPTION OF THE DRAWINGS

The accompanying drawings incorporated in the specification illustrate several aspects of the present invention and together with the description serve to explain the principles of the invention. In the drawings:

FIG. 1 is a top plan view of two lens sheets, one with the lenses horizontal and one with the lenses vertical.

FIG. 2 is a front view of a desktop printer.

FIG. 3 is a front view of a wide format printer.

FIG. 4 is a side view of a lens sheet cross section with one lens coating.

FIG. 5 is a side view of a lens sheet cross section with two lens coatings.

FIG. 6 is a cross section lens view with one and two coatings.

FIG. 7a. is a cross section lens view with a single clear coating.

FIG. 7b. is a cross section lens view with either a white coating or a clear coating.

FIG. 7c. is a cross section lens view with a clear coating and a white coating.

FIG. 8 is a side view of a lens roll with an enlarged view of the lenses.

FIG. 9 is a top view of the white coated back side of the lens as it enters a wide format printer.

FIG. 10 is a top view of the white coated back side of the lens as it is being printed.

FIG. 11 is a cross section of the lens showing curvature when laminated on one side.

FIG. 12a. is a top view of the lenses coated with the white material.

FIG. 12b. is a top view of the lenses after lamination.

### DETAILED DESCRIPTION OF THE PREFERRED EMBODIMENT

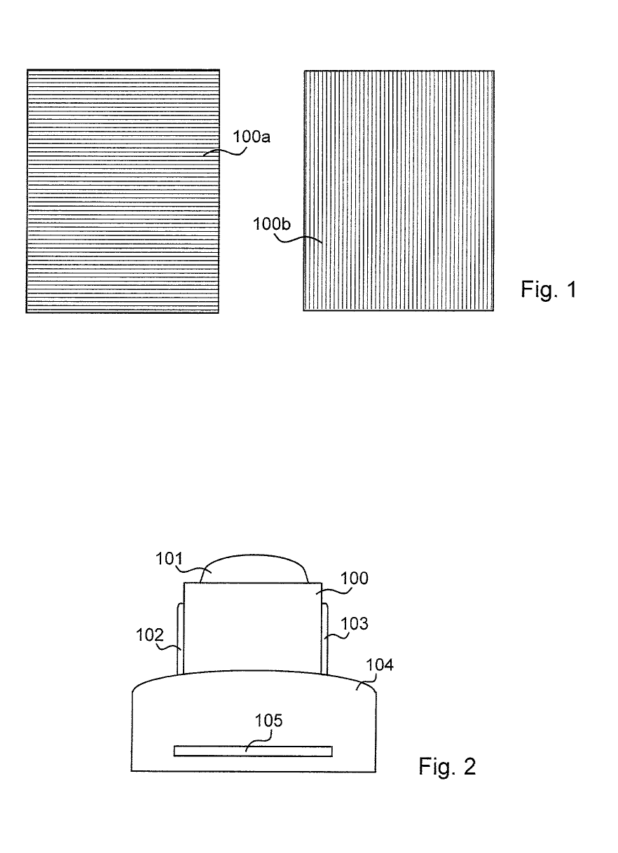

Referring to FIG. 1 there is shown two sheets of clear material that have lenticular lenses formed on one side of each sheet in a horizontal direction, 100a and a vertical direction, 100b. The lens sheets will be of a predetermined thickness and number of lines per inch (LPI). The lens sheets may be inserted into a printer in either direction. Current lenticular printing requires the lenses to be inserted vertically. In this embodiement the lenses can be cut to different sizes or be in roll form to fit each type of printer.

Referring to FIG. 2 there is shown a typical desktop printer, 104 with a lenticular lens, 100 inserted into the printer in front of the media holder, 101. Side bar aligners, 102 and 103 are shown on either side of the lens sheet marking the registration point. They will be exactly 90° from the lens direction on 100a and exactly parallel to the lens direction on 100b providing a perfect edge to edge registration of the lens. 105 shows the output slot of the printer.

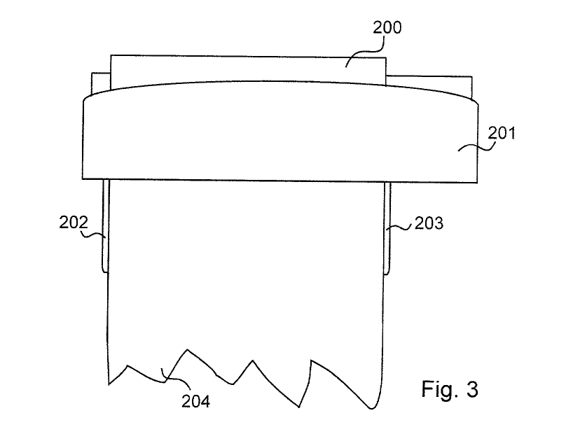

Referring to FIG. 3 there is shown a wide format printer, 201. Alignment bars 202 and 203, mark the exact width of the large lens sheet or roll material, 204. Again the bars are 90° from a horizontal lens direction and parallel to a vertical lens direction determining the proper printing registration of the lenses.

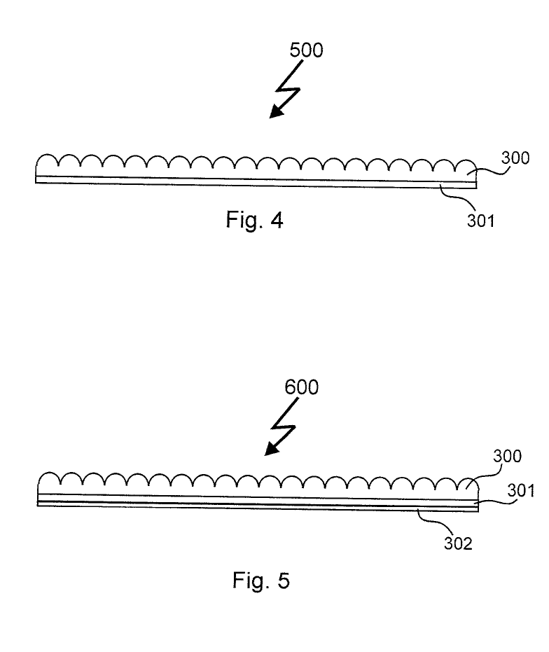

Referring to FIG. 4 there is shown a cross section of a lenticular lens sheet showing the lenses, 300 on top and an inkjet coating layer, 301 applied to the bottom. The lens sheet is made of a clear material and the inkjet coating application is clear. The inkjet coating allows the image to be printed on the backside of the lens.

Referring to FIG. 5 there is shown a cross sectional side view of a lenticular lens sheet. The lenses, 300 are shown on top with the inkjet printable coating, 301 on the bottom. An additional white, microporous coating, 302 is applied over the first coating. This thin coating allows printed images to be seen from the front through the lenses providing a white background to enhance the images. This particular coating, 302 also allows the printed images seen through the lens to be backlit as in a light box with the light shining through both coatings and the lens.

Referring to FIG. 6 there is shown two views, 500 and 600 with two cross sections of lens material, 300 and a printer head 303 with an ink drop, 304. The first clear coating, 301 in view 500 is followed by the second white coating, 302 in view 600. The ink drop, 305 is visible on the clear coating, 301. Inkdrop, 306 in view 600 is not visible while inkdrop 307 is visible due to the white coating, 302 creating a higher resolution image.

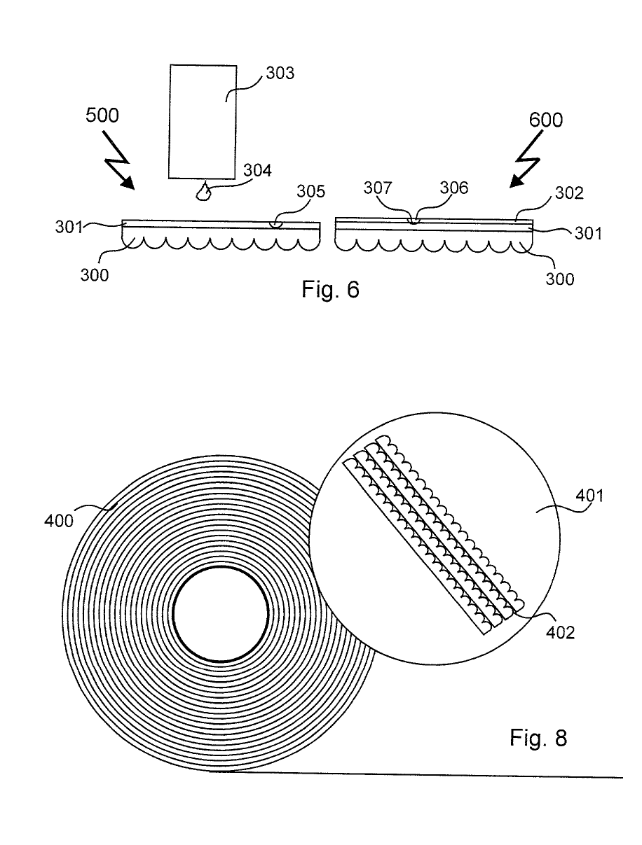

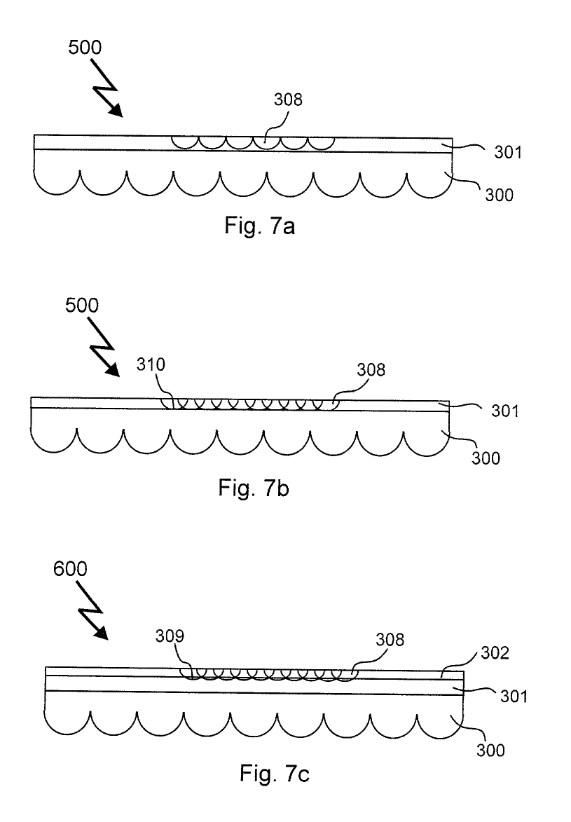

Referring to FIG. 7a. in an enlarged depiction of view, 500 the lens, 300 and the clear coating, 301 show an inkdrop, 308 that is a normal resolution image.

Referring to FIG. 7b. in an enlarged depiction of view, 500 the lens, 300 and a white single coating, 301 shows an inkdrop, 308 which is not visible through the clear coating and an inkdrop, 310 which is visible through the white coating creating a higher resolution image.

Referring to FIG. 7c. in an enlarged depiction of view, 600 the lens, 300 has the clear coating, 301 and the white coating, 302 applied. An inkdrop, 308 which is visible and an inkdrop, 309 which is visible creating smaller drops with higher density and resolution when passing through the white coating, 302 as seen from the lens side, 300.

Referring to FIG. 8 there is shown a side view of a large lens roll, 400 with a cross section, 401 of the rolled lenses, 402. These lenses, 402 must have both clear and white coatings applied in the proper thickness and quick drying process so that they can be rolled without damaging the lenses.

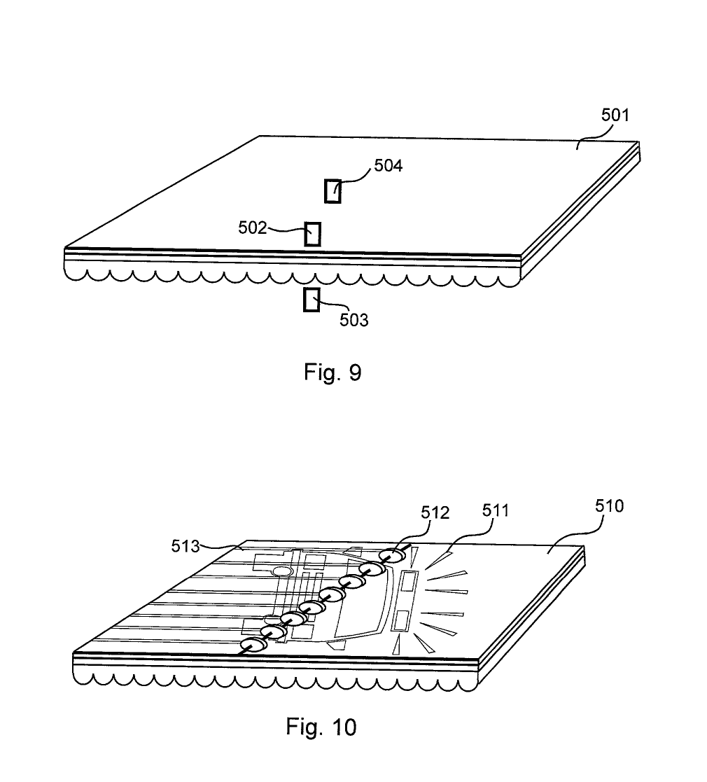

Referring to FIG. 9 there is shown a top view of the coated back side of the lens, 501 as it enters a wide format printer. The light sensor, 502 senses the white coating emitting light, 503. The CCD alignment sensor, 504 in most high end printers sets the ink drop in the proper position for printing. If the lens is clear without the white coating the sensor will not recognize the media.

Referring to FIG. 10 there is shown a top view of the white coated back side of the lens, 510 as it is being printed, 511. The roller set, 512 pulling the lens media through the printer causes scratches, 513 on the top surface. If the lens coating is the white material the scratches will not show through to the lens side. If the coating is clear the scratches will show.

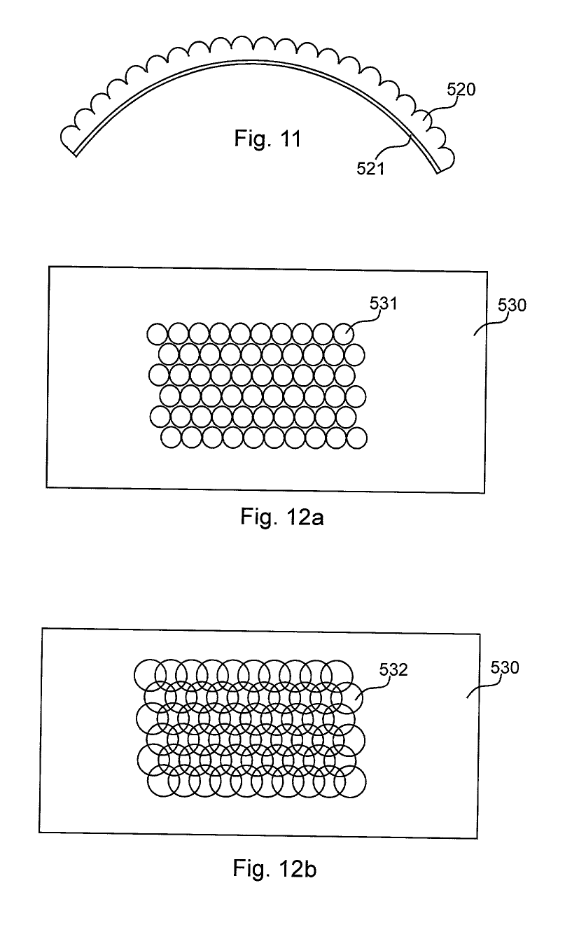

Referring to FIG. 11 there is shown a cross section of the lens, 520 that is laminated on one side only, 521 causing an unnatural bend in the lens. The lens side cannot be laminated as it will damage the printed image. The white coating eliminates the need for any lamination

Referring to FIG. 12a. there is shown a top view of the lens, 530 coated with white material and an ink drop, 531 that is full resolution to the printer manufacturers spec with 100% quick dry and no need to laminate.

Referring to FIG. 12b. there is shown a top view of the lens, 530 after lamination showing the degradation of the printed image, 532 from either heat or pressure as opposed to the high resolution image, 531 in FIG. 12a. that has not been laminated.

What is claimed is:

1. A printing process whereby lenticular lenses can be printed upon directly with a variety of low cost color inkjet printers 600 DPI and above as well as wide format inkjet printers.

2. The inkjet printing of claim 1 that is accomplished without requiring film or complex interlacing techniques to print directly on the lens sheets.

3. The lenticular lenses of claim 1 that can be cut and printed for 3-D and animation images either horizontally or vertically and in different sizes including rolls.

4. The lenses of claim 2 that are aligned either 90° from or parallel to the alignment bars of desktop printers and wide format printers depending on the lens orientation creating exact registration.

5. The printing process of claim 2 that requires directly printable lens material of minimal thickness and increased lines per inch to maximize print quality and results of lenticular imaging.

6. The use of thinner lens material that is softer and more pliable for ease of insertion into all types of printers without reducing the quality of the image.

7. The lenses of claim 1 that take the place of laminating to protect the ink.

8. The clear inkjet coating material that is applied to the back of the lenticular lens in the correct process to provide proper adhesion for the coating and printability.

9. The use of a white lens coating material that is inkjet printable through the coating to replace solid white adhesive backing.

10. The white lens coating material of claim 7 that is microporous allowing backlit light through the lens.

11. The microporous white lens coating material in claim 8 that provides a white background for the images printed on the lens.

12. The white lens coating material of claim 7 that is quick dry preventing the printed roll from sticking, causing quality problems with the printed image.

13. The white lens coating microporous material of claim 8 that increases the resolution of the lens when printed.

14. The white coating material of claim 7 that allows 3-D animation printing on the back of lenses in an easier, lower cost, process for both desktop and wide format printers reducing the process by one step.

15. The white coating material of claim 7 that allows wide format printers to recognize the lenticular clear lens to enable the printing process.

16. The white coating material of claim 7 that provides UV protection for longer ink life for the image.

17. The white coating material of claim 7 that will not show scratches or fingerprints.

18. The white coating material of claim 7 that avoids the necessity for hot or cold lamination that would cause distortion of the image.

19. The white coating material of claim 7 that eliminates the need for single side lamination that causes curling of the final product.
